(19) United States
(12) Patent Application Publication
(10) Pub. No.: US 2019/0320432 A1
(43) Pub. Date: Oct. 17, 2019

(54) Extended Data Indication for Indication of DPCCH Decoding Problems

(71) Applicant: Parallel Wireless, Inc., Nashua, NH (US)

(72) Inventors: Eric Mrozinski, Westford, MA (US); Pankaj Chaurasia, Bangalore (IN); Biswajeet Kumar, Bangalore (IN)

(21) Appl. No.: 16/383,134

(22) Filed: Apr. 12, 2019

Related U.S. Application Data
(60) Provisional application No. 62/657,408, filed on Apr. 13, 2018.

(51) Int. Cl. H04W 72/04; H04L 5/00; H04L 1/00; H04W 52/24; H04W 52/14; H04W 52/12; H04W 52/36

(52) U.S. Cl. CPC H04W 72/0413; H04L 5/0044; H04L 1/0072; H04L 5/0053; H04W 52/367; H04W 52/24; H04W 52/146; H04W 52/125; H04W 72/0446

(57) ABSTRACT

Systems, methods and computer programs are disclosed for providing an indication of a decoding problem in a wireless system. A problem is detected in decoding uplink physical control channels for a Dedicated Physical Control Channel (DPCCH) or an Enhanced Dedicated Physical Control Channel (E-DPCCH). A modified Up Link (UL) Dedicated Channel (DCH) frame having a spare field modified to indicate a Transport Format Combination Indicator (TFCI) decode failure is sent. In response to receiving the modified UL DCH frame, an Up Link (UL) Outer-Loop Power Control (OLPC) is controlled to keep a signal-to-interference ratio (SIR) of the UL DPCCH within a predetermined range.

### CROSS-REFERENCE TO RELATED APPLICATIONS

This application claims priority under 35 U.S.C. § 119(e) to U.S. Provisional Pat. App. No. 62/657,408, filed Apr. 13, 2018, titled “Extended Data Indication for Indication of DPCCH Decoding Problems” which is hereby incorporated by reference in its entirety for all purposes. This application also hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety. The purposes for the above incorporations by reference include at least to provide detailed information about the features and functionality of the Parallel Wireless CWS (RAN) and HNG (coordinator) products. Also incorporated by reference in their entirety are ETSI TS 125 427, Universal Mobile Telecommunications System (UMTS) UTRAN Iub/Iur interface user plane protocol for DCH data streams (3GPP TS 25.427); and ETSI TS 125 214, Universal Mobile Telecommunications System (UMTS); Physical Layer Procedures (FDD) (3GPP TS 25.214)

### BACKGROUND

The 3GPP specifications don't foresee built-in/algorithmic means to identify and address physical channel decoding issues. There is no message or message element defined by which L1 informs the Radio Network Controller (RNC)/Outer-Loop Power Control (OLPC) about decoding problems. Channel quality problems are monitored by L1 internally, and decisions are taken by L1 itself (i.e. qualification of a radio link failure). Also, 3GPP doesn't specify an algorithm for OLPC. 3GPP has introduced the uplink power control (inner- and outer-loop, Inner-Loop Power Control (ILC) and OLPC), respectively) to control decoding problems” (block error rate) on uplink Data channels, but not on the UL Physical Control channels.

### SUMMARY OF THE INVENTION

The invention relates generally to messaging to indicate decoding problems, and in particular, to an extended data indication for decoding problems such that power control can be implemented to ensure the physical channels are decodable.

In a first embodiment, a method is disclosed for providing an indication of a decoding problem, comprising: detecting a problem in decoding uplink physical control channels for a Dedicated Physical Control Channel (DPCCH) or an Enhanced Dedicated Physical Control Channel (E-DPCCH); sending a modified Up Link (UL) Dedicated Channel (DCH) frame having a spare field modified to indicate a Transport Format Combination Indicator (TFCI) decode failure; and in response to receiving the modified UL DCH frame, controlling an Up Link (UL) Outer-Loop Power Control (OLPC) to keep a signal-to-interference ratio (SIR) of the UL DPCCH within a predetermined range.

Sending the modified UL DCH frame may be used for 2G, 3G, 4G, Long-Term Evolution (LTE) or 5G Radio Access Technologies (RATs). The OLPC may use the modified UL DCH frame to readjust gain factors. The OLPC may use the modified UL DCH frame to readjust power offsets. The OLPC may use the modified UL DCH frame to optimize power consumption of uplink control and data channels to maximize cell capacity. The OLPC may use the modified UL DCH frame offline to readjust gain factors. The OLPC may use the modified UL DCH frame offline to readjust power offsets. The OLPC may use the modified UL DCH frame offline to optimize power consumption of uplink control and data channels to maximize cell capacity. The OLPC may use the modified UL DCH frame to set a low-bound limit in an SIR target to ensure the DPCCH and the E-DPCCH SIR do not fall below the low-bound limit.

In a further embodiment, a non-transitory computer-readable medium is disclosed containing instructions which, when executed, cause a wireless communications system to perform steps comprising: detecting a problem in decoding uplink physical control channels for a Dedicated Physical Control Channel (DPCCH) or an Enhanced Dedicated Physical Control Channel (E-DPCCH); sending a modified Up Link (UL) Dedicated Channel (DCH) frame having a spare field modified to indicate a Transport Format Combination Indicator (TFCI) decode failure; and in response to receiving the modified UL DCH frame, controlling an Up Link (UL) Outer-Loop Power Control (OLPC) to keep a signal-to-interference ratio (SIR) of the UL DPCCH within a predetermined range.

The modified UL DCH frame may be used for 2G, 3G, 4G, Long-Term Evolution (LTE) or 5G Radio Access Technologies (RATs). The OLPC may use the modified UL DCH frame to readjust gain factors The OLPC may use the modified UL DCH frame to readjust power offsets. The OLPC may use the modified UL DCH frame to optimize power consumption of uplink control and data channels to maximize cell capacity. The OLPC may use the modified UL DCH frame offline to readjust gain factors. The OLPC may use the modified UL DCH frame offline to readjust power offsets. The OLPC may use the modified UL DCH frame offline to optimize power consumption of uplink control and data channels to maximize cell capacity. The OLPC may use the modified UL DCH frame to set a low-bound limit in an SIR target to ensure the DPCCH and the E-DPCCH SIR does not fall below the low-bound limit.

In a further embodiment, a system is disclosed for providing an indication of a decoding problem, comprising: a User Equipment (UE); a base station in wireless communication with the UE; wherein a problem is detected by the UE in decoding uplink physical control channels for a Dedicated Physical Control Channel (DPCCH) or an Enhanced Dedicated Physical Control Channel (E-DPCCH); wherein, in response to the problem being detected, a modified Up Link (UL) Dedicated Channel (DCH) frame is sent by the UE to the base station, the frame having a spare field modified to indicate a Transport Format Combination Indicator (TFCI) decode failure; and wherein, in response to the base station receiving the modified UL DCH frame, an Up Link (UL) Outer-Loop Power Control (OLPC) is controlled to keep a signal-to-interference ratio (SIR) of the UL DPCCH within a predetermined range.

In a further embodiment, a method is disclosed for providing an indication of a decoding problem, comprising: detecting a problem in decoding uplink physical control channels sending a modified Up Link (UL) frame having a spare field modified to indicate a decode failure; and in response to receiving the modified UL frame, controlling an Up Link (UL) Outer-Loop Power Control (OLPC) to keep a signal-to-interference ratio (SIR) of the uplink physical control channels within a predetermined range.

Sending the modified UL frame may be used for 2G, 3G, 4G, Long-Term Evolution (LTE) or 5G Radio Access Technologies (RATs). The OLPC may use the modified UL frame to readjust gain factors. The OLPC may use the modified UL frame to readjust power offsets. The OLPC may use the modified UL frame to optimize power consumption of uplink control and data channels to maximize cell capacity. The OLPC may use the modified UL frame offline to readjust gain factors. The OLPC may use the modified UL frame offline to readjust power offsets. The OLPC may use the modified UL frame offline to optimize power consumption of uplink control and data channels to maximize cell capacity. The OLPC may use the modified UL frame to set a low-bound limit in an SIR target to ensure the UL physical control channel SIR does not fall below the low-bound limit.

In a further embodiment, a non-transitory computer-readable medium is disclosed containing instructions which, when executed, cause a wireless communications system to perform steps comprising: detecting a problem in decoding uplink physical control channels; sending a modified Up Link (UL) frame having a spare field modified to indicate a decode failure; and in response to receiving the modified UL frame, controlling an Up Link (UL) Outer-Loop Power Control (OLPC) to keep a signal-to-interference ratio (SIR) of the UL physical control channels within a predetermined range.

The modified UL frame may be used for 2G, 3G, 4G, Long-Term Evolution (LTE) and 5G Radio Access Technologies (RATs). The OLPC may use the modified UL frame to readjust gain factors. The OLPC may use the modified UL frame to readjust power offsets. The OLPC may use the modified UL frame to optimize power consumption of uplink control and data channels to maximize cell capacity. The OLPC may use the modified UL frame offline to readjust gain factors. The OLPC may use the modified UL frame offline to readjust power offsets. The OLPC may use the modified UL frame offline to optimize power consumption of uplink control and data channels to maximize cell capacity. The OLPC may use the modified UL frame to set a low-bound limit in an SIR target to ensure UL physical control channel SIR does not fall below the low-bound limit.

In a further embodiment, a system for providing an indication of a decoding problem is disclosed, comprising: a User Equipment (UE); a base station in wireless communication with the UE; wherein a problem is detected by the UE in decoding uplink physical control channels wherein, in response to the problem being detected, a modified Up Link (UL) frame is sent by the UE to the base station, the frame having a spare field modified to indicate a decode failure; and wherein, in response to the base station receiving the modified UL frame, an Up Link (UL) Outer-Loop Power Control (OLPC) is controlled to keep a signal-to-interference ratio (SIR) of the physical control channel within a predetermined range.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 depicts a diagram of an uplink data transfer procedure for DCH, in accordance with some embodiments.

FIG. 2 depicts a diagram of an uplink data transfer procedure for E-DCH, in accordance with some embodiments.

FIG. 3 depicts a diagram a UL data frame structure, in accordance with some embodiments.

FIG. 4 depicts a diagram of an E-DCH UL data frame structure, in accordance with some embodiments.

FIG. 5 depicts a diagram of a channel structure with HSDPA and HSUPA, in accordance with some embodiments.

FIG. 6 is a schematic diagram of an enhanced eNodeB, in accordance with some embodiments.

### DETAILED DESCRIPTION

The existing Uplink (UL) DATA FRAME messages for DCH and E-DCH are extended to allow L1 (Node-B) to provide information to the L2/L3 protocol stack (RNC) about the L1's success in decoding the uplink physical control channels DPCCH and E-DPCCH (DPCCH and E-DPCCH quality). This information is used by the uplink outer-loop power control algorithm to adjust Signal Interference Ratio (SIR) target, with the goal to assure that both those channels are reliably decoded at all times.

The information is used to flag a phase of too low quality, e.g. if the Transport Format Combination Indicator (TFCI) bits (case of DPCCH) or the E-TFCI bits (case of E-DPCCH) are not decodable. Other criteria for low quality may also be used (e.g. SIR of pilot bits in case of DPCCH).

Flagging a too low quality radio frame is provided as feedback to assess the reliability of the radio link, thereby improving voice and data quality.

A Dedicated Transport Channel (DCH) frame protocol provides several services, including but not limited to: transport of outer loop power control information between the Serving Radio Network Controller (SRNC) and the Node B, support of a transport channel synchronization mechanism, support of a node synchronization mechanism, transfer of radio interface parameters from the SRNC to the Node B, transport of outer loop power control information between the SRNC and the Node B, transfer of radio interface parameters from the SRNC to the Node B, and transport of network congestion indication signal from SRNC.

An Enhanced-DCH (E-DCH) frame protocol provides several services, including but not limited to: transport of outer loop power control information between the SRNC and the Node B, transfer of radio interface parameters from the SRNC to the Node B, and transport of network congestion indication signal from SRNC.

Transport Format Combination Indictor (TFCI) is an indicator designating a transport format combination. TFCI bits are multiplexed into a DPCCH of each DCH. At the receiver, the TFCI bits are used to decode Layer 1 (L1) L1 data sequences and to demultiplex transport blocks transferred on a physical channel.

UMTS requires as much power efficiency as possible, especially on the uplink. The goal is to apply on the uplink channels as little power as possible while still meeting QoS requirements (e.g. block error rate—BLER). Outer- and inner-loop power control have a key role in here, but also crucial is to determine the optimal values for various gain factors and power offsets.

The risk in maximizing power efficiency is that the important uplink physical control channels (DPCCH and E-DPCCH) are under-powered and cannot be reliably decoded. This should be prevented.

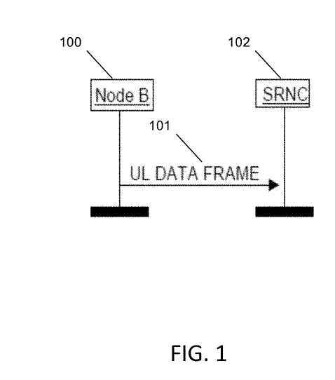

Referring to FIG. 1, a UL data frame transport diagram is shown. A Node B 100 transmits the UL data frame 101 to the SRNC 102. When there is some data to be transmitted, DCH data frames are transferred every transmission time interval from the SRNC to the Node B for downlink transfer, and DCH/E-DCH data frames are transferred every transmission time interval from Node B to the SRNC for uplink transfer. An optional error detection mechanism may be used to protect the data transfer if needed. At the transport channel setup it is specified if the error detection on the user data is used.

Two modes can be used for the UL transmission: normal mode and silent mode. The mode is selected by the SRNC when the transport bearer is set up and signaled to the Node B with the relevant control plane procedure.

In normal mode, the Node B will always send an UL DATA FRAME to the RNC for all the DCHs in a set of coordinated DCHs regardless of the number of Transport Blocks of the DCHs.

In silent mode and in case only one transport channel is transported on a transport bearer, the Node B will not send an UL DATA FRAME to the RNC when it has received a TFI indicating “number of TB equal to 0” for the transport channel during a TTI.

In silent mode and in case of coordinated DCHs, when the Node B receives a TFI indicating “number of TB equal to 0” for all the DCHs in a set of coordinated DCHs, the Node B shall not send an UL DATA FRAME to the RNC for this set of coordinated DCHs. For any TTI in which the Node B Layer 1 generated at least one CPHY-Out-of-Sync-IND primitive, the Node B is not required to send an UL DATA FRAME to the SRNC. When Node B receives an invalid TFCI, no UL DATA FRAME is sent to the SRNC.

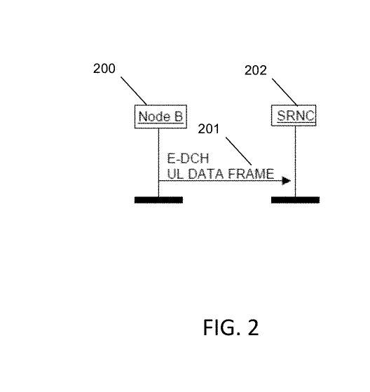

Referring to FIG. 2, an E-DCH UL data frame transport diagram is shown. A Node B 200 transmits the E-DCH UL data frame 201 to the SRNC 202. When a MAC-e PDU is received, it is demultiplexed into MAC-d flows which are then each sent on separate transport bearers to the RNC using the E-DCH UL DATA FRAME. Only silent mode is used, i.e. E-DCH user-plane payload is transmitted using the E-DCH UL DATA FRAME only when some payload has been successfully received.

In order to provide an indication of DPCCH decoding problems, the existing UL DATA FRAME messages for DCH and E-DCH are extended to allow L1 (Node-B) to provide information to the L2/L3 protocol stack (RNC) about the L1's success in decoding the uplink physical control channels DPCCH and E-DPCCH (DPCCH and E-DPCCH quality). This information is used by the uplink outer-loop power control algorithm to adjust SIR-target, with the goal to assure that both those channels are reliably decoded at all times.

The information includes a flagging a phase of too low quality, e.g. if the TFCI bits (case of DPCCH) or the E-TFCI bits (case of E-DPCCH) are not decodable. Other criteria for low quality may also be used (e.g. SIR of pilot bits in case of DPCCH).

Flagging a too low quality radio frame can be provided as feedback to assess reliability of the radio link, thereby improving voice and data quality.

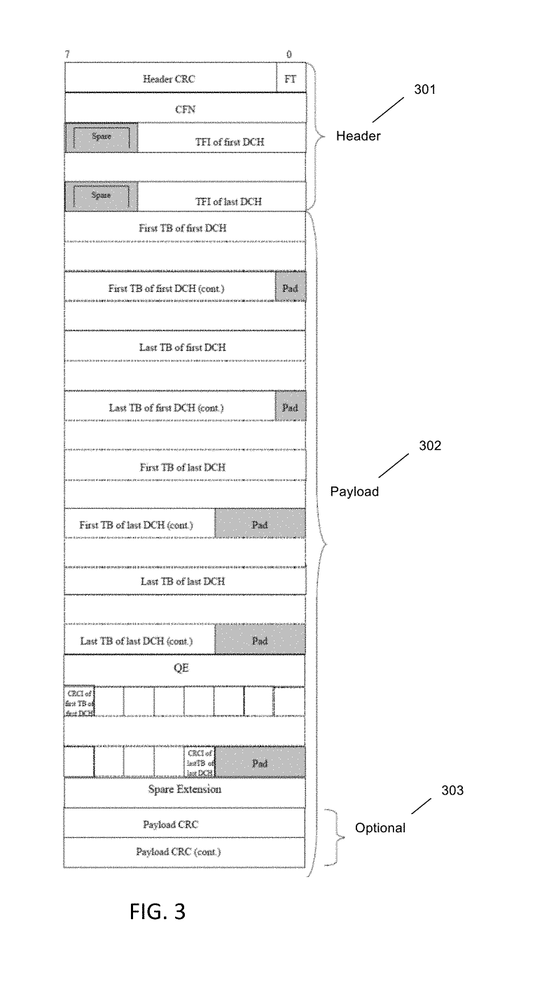

FIG. 3 comprises a diagram of a UL Data Frame Structure. The UL data frame includes header section 301, a payload section 302 and an optional section 303. Also shown is spare section 304. The spare section of the header section is shown below.

Proposed Modification to UL DCH Frame

| | | | | | | | |
|---|---|---|---|---|---|---|---|
| 7 | 6 | 5 | 4 | 3 | 2 | 1 | 0 |

| | | |
|---|---|---|
| Byte1 | Header CRC | FT |

| | |
|---|---|
| Byte2 | CFN |

| | | |
|---|---|---|
| Byte3 | Spare (111) | TFCI |

The first byte of UL DCH frame indicates the Header CRC and Frame Type. The second byte contains CFN. The third byte contains 5 bits for TFCI value of DCH, and 3 spare bits. The 25.437 specification, § 6.1.1, says “bits labeled ‘spare’ shall be set to zero by the transmitter and shall be ignored by the receiver.” These 3 spare bits are used to indicate TFCI decode fail indication to L2. In one example, the spare bits are set to 111 to indicate TFCI Decode failure, although any other value except 000 could be used. The five lower bits in this specific case are irrelevant/ignored because the block was undecodable due to the TFCI decoding error.

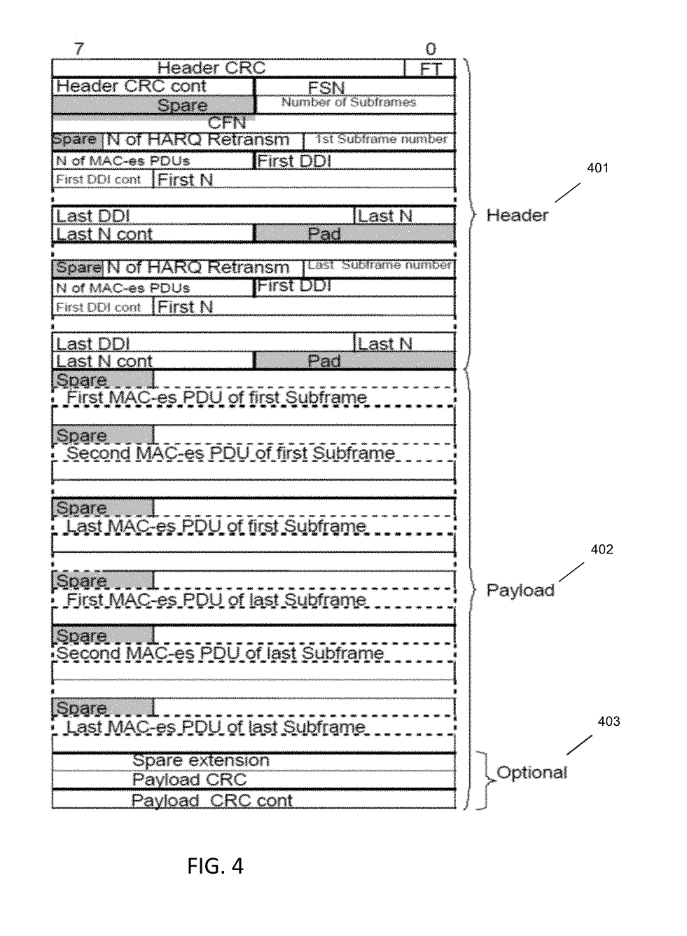

Referring now to FIG. 4, an E-DCH UL data frame is shown. This data frame includes a header section 401, a payload section 402 and an optional section 403. Also shown is a spare section 404. Similar to the spare section in the UL data frame shown in FIG. 3, the spare section is also modified in a similar manner to indicate a TFCI decode problem.

UL outer-loop power control (OLPC) can prevent DPCCH and E-DPCCH decoding problems by making use of the information for adjusting/keeping the target signal-to-interference ratio of the UL DPCCH (“SIR-tgt”) sufficiently high. Those problems can occur on both channels DPCCH and E-DPCCH, but the control and adjustment of SIR-tgt allows to address both.

The information itself, and OLPC's processing of that information, can also be used “off-line”, to re-adjust gain factors, power offsets and OLPC algorithm parameters with the goal to optimize power consumption of all uplink control and data channels and hence maximize cell capacity and number of served users. OLPC controls uplink power by increasing uplink transmission power when downlink signal attenuation increases as a distance between the UE and the base station increases. The OLPC controls uplink power in such a manner that the base station directly transmits information (i.e. a control signal) necessary to control uplink transmission power.

The same or similar method could be used with other frame types and other radio access technology or G's, as well as for interoperability and handover with these other RATs.

OLPC can, with this additional information, set some low-bound limits in SIR-target, to assure (DPCCH- and E-DPCCH-) SIR doesn't fall below required level. Also, this information, when traced out, can support the process of optimizing gain factors and power offset values “off-line”, to further increase power efficiency.

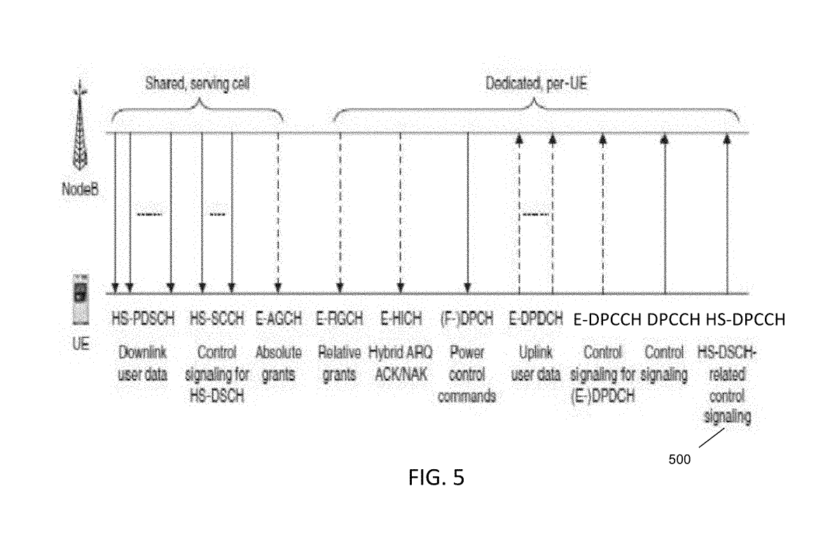

Referring now to FIG. 5, a High Speed Dedicated Physical Control Channel (HS-DPCCH) 500 is shown. HS-DPCCH is an HSDPA channel used to provide feedback to the scheduler and it is located in the uplink.

These new channels, HS-DSCH, HS-SCCH, & HS-DPCCH provide the high speed data capability along with the other improvements added to HSDPA including higher order modulation adaptive HARQ and improved scheduling.

The HS-DPCCH channel carries the following information:

HARQ ACK/NAK information which is used to provide information back about the successful receipt and decoding of information and hence to request the resending information that has not been successfully received.

Channel Quality Information which is used to provide instantaneous channel information to the scheduler. The HS-DSCH related control signaling signals are used to indicate a TFCI decode problem.

In 2G, the present disclosure should be interpreted to apply to feedback for decode for any or all of the following channels: broadcast control channel (BCCH), common control channel (CCCH), dedicated control channel (DCCH), frequency correction channel (FCCH), synchronization channel (SCH), paging channel (PCH), random access channel (RACH), access granted channel (AGCH), stand alone dedicated control channel (SDCCH), slow associated control channel (SACCH), fast associated control channel (FACCH), or their equivalents.

In 3G, the present disclosure should be interpreted to apply to feedback for decode for any or all of the following channels: (enhanced) dedicated channel (E-DCH/DCH), (enhanced) dedicated control channel (E-DCCH/DCCH), common control channel (E-CCCH/CCCH), shared channel control channel (SHCCH), physical random access channel (PRACH), primary and secondary common control physical channel (PCCPCH/SCCPCH), (enhanced) dedicated physical control channel (E-DPCCH/DPCCH), E-AGCH, E-RGCH, E-HICH, as well as E-UTRA enhanced versions thereof.

In 4G, the present disclosure should be interpreted to apply to feedback for decode for any or all of the following channels: physical uplink control channel (PUCCH), physical uplink shared channel (PUSCH), physical random access channel (PRACH), uplink shared channel (UL-SCH), random access channel (RACH), as well as variations and equivalents thereof.

The present disclosure should be interpreted to apply to feedback for decode for any or all 5G PDCCH, 5G E-DPCCH, or other 5G control channels. It is noted that the 5G control channels, including broadcast control channel (BCCH), paging control channel (PCCH), common control channel (CCCH), dedicated control channel (DCCH), dedicated traffic channel (DTCH) are very similar to those used by LTE and thus it is understood that the application of the present disclosure to 5G NR shall be straightforward.

The inventors have contemplated the use of any extension of uplink messages to provide uplink physical control channel decode success information from the L1 of a base station to the L2/L3 of a base station. This method can be used within any radio access technology, for example, for 2G, 3G, 4G, 5G, or Wi-Fi. This method can be used for feedback of L1 link decode information for any channel, not just a physical control channel. It is noted that different radio access technologies (RATs) will have different placement or arrangement of L1, L2, and L3, as well as differences in prescribed messages; and in some cases a message as described herein may be replaced by, for example, shared memory, out-of-band messages, IP messages, SCTP messages, or new messages that are not sent as part of existing protocol messages. This method can be used for feedback from any L1 to any L2 and/or combined L2/L3; this includes various different configurations of L1 and L2/L3, including remote baseband, distributed baseband, remote radio head, RNC, virtual RNC, virtual base station as provided by the Parallel Wireless HetNet Gateway or other base station virtualization system.

The inventors have contemplated a power control algorithm, including an outer loop power control algorithm, that (1) receives other inputs as required by OLPC; (2) receives inputs from uplink decode success information, as described herein; (3) performs power control based on the uplink decode success information, as described herein. OLPC is understood to be in the art and can be enhanced to take into account the uplink decode success information.

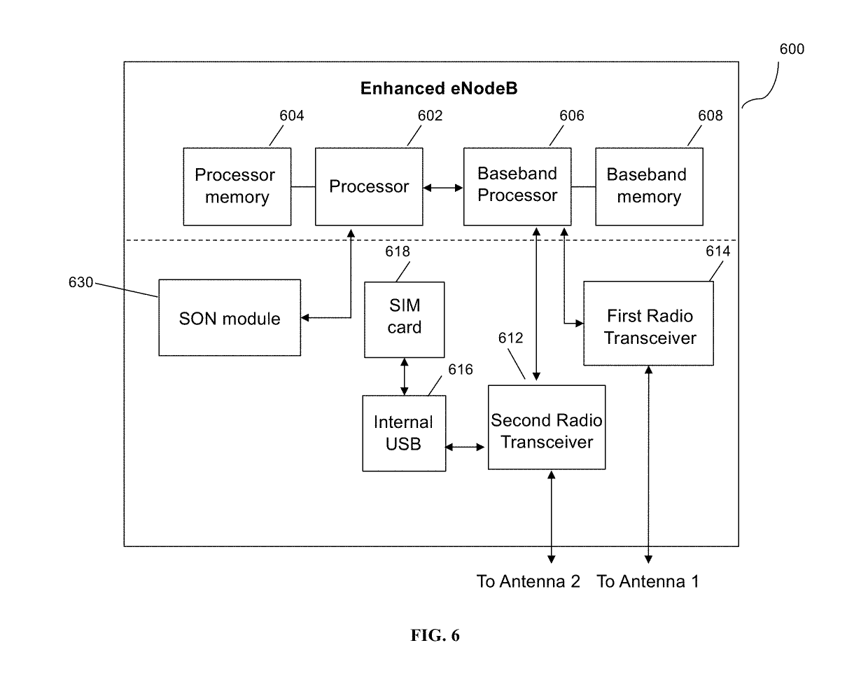

FIG. 6 is a schematic diagram of an enhanced eNodeB, in accordance with some embodiments. Enhanced eNodeB 600 may include processor 602, processor memory 604 in communication with the processor, baseband processor 606, and baseband processor memory 608 in communication with the baseband processor. Enhanced eNodeB 600 may also include first radio transceiver 614 and second radio transceiver 612, internal universal serial bus (USB) port 616, and subscriber information module card (SIM card) 618 coupled to USB port 616. In some embodiments, the second radio transceiver 612 itself may be coupled to USB port 616, and communications from the baseband processor may be passed through USB port 616.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

The first radio transceiver 614 may be a radio transceiver capable of providing LTE eNodeB functionality, and may be capable of higher power and multi-channel OFDMA. The second radio transceiver 612 may be a radio transceiver capable of providing LTE UE functionality. Both transceivers 612 and 614 are capable of receiving and transmitting on one or more LTE bands. In some embodiments, either or both of transceivers 612 and 614 may be capable of providing both LTE eNodeB and LTE UE functionality. Transceiver 614 may be coupled to processor 602 via a Peripheral Component Interconnect-Express (PCI-E) bus, and/or via a daughtercard. As transceiver 612 is for providing LTE UE functionality, in effect emulating a user equipment, it may be connected via the same or different PCI-E bus, or by a USB bus, and may also be coupled to SIM card 618.

SIM card 618 may provide information required for authenticating the simulated UE to the evolved packet core (EPC). Information may be stored within the SIM card 618, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections may be used for either access or backhaul, according to identified network conditions and needs, and may be under the control of processor 602 for reconfiguration.

Other elements and/or modules may also be included, such as a home eNodeB, a local gateway (LGW), a self-organizing network (SON) module, or another module. Additional radio amplifiers, radio transceivers and/or wired network connections may also be included.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 612 and 614. Baseband processor 606 may also perform operations to decode signals received by transceivers 612 and 614. Baseband processor 606 may use memory 608 to perform these tasks.

The foregoing discussion discloses and describes merely exemplary embodiments of the present invention. As will be understood by those skilled in the art, the present invention may be embodied in other specific forms without departing from the spirit or essential characteristics thereof. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and system can generally be integrated together in a single software product or packaged into multiple software products.

The above-described features and applications can be implemented as software processes that are specified as a set of instructions recorded on a computer-readable storage medium (also referred to as computer readable medium). When these instructions are executed by one or more processing unit(s) (e.g. one or more processors, cores of processors, or other processing units), they cause the processing unit(s) to perform the actions indicated in the instructions. Examples of computer readable media include, but are not limited to, CD-ROMs, flash drives, hard drives, RAM chips, EPROMs, etc. The computer-readable media does not include carrier waves and electronic signals passing wirelessly or wired connections. Code may be written in any combination of programming languages or machine-readable data formats, each suitable to its particular application, including but not limited to: C, C++, Java, Python, Ruby, R, Lua, Lisp, Scala, JSON, JavaScript, YAML, XML, HTML, etc. Services may be RESTful and may be implemented using generic hooks, including over HTTP, HTTPS, SCTP, IP, TCP, JSON, JavaScript, etc., as well as via inter-process communication on one or more real or virtual machines or containers, e.g., IPC, shared memory, shared filesystem, UNIX pipes and the like. A Linux or POSIX environment may be used. Containers may be Docker, Jetty, Tomcat, Wildfy, Springboot, LXD, unikernels, OpenVZ, RKT, Windows Server, Hyper-V, or any other type of container, or may be, in some embodiments, virtual machines or images, etc. Network access may be relied upon or may be avoided, in various embodiments. A networking fabric may be provided among the different containers, in some embodiments. As is well-known, the benefit of using cloud infrastructure is that it is simple to mix heterogeneous resources and to scale services up or down based on load and desired performance.

In the specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronics systems, define one or more specific machine implementations that execute and perform the operations of the software programs.

A computer program (also known as program, software, software application, script, or code) can be written in any form of programming language, including compiled or interpreted languages, declarative or procedural languages, and it can be deployed in any form, including as a standalone program or as a module, component, subroutine, object, or another unit suitable for use in a computing environment. A computer program may, but need not correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

These functions described above can be implemented in digital electronic circuitry, in computer software, hardware, or firmware. The techniques can be implemented using one or more computer program products. Programmable processors and computers can be included in or packaged as mobile devices. The process and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), readable compact discs (CD-R), rewritable compact discs (CD-RW), read-only digital versatile discs (e.g., DVD-ROM, dual-layer DVD-ROM), a variety of recordable/rewritable DVDs (e.g. DVD-RAM, DVD-RW, DVD+RW, etc.), flash memory (e.g., SD cards, mini-SD cards, micro-SD cards, etc.), magnetic or solid-state hard drives, read-only and recordable Blu-Ray® discs, ultra-density optical discs, any other optical or magnetic media, and floppy disks. The computer-readable media can store a computer program that is executed by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored in the circuit itself.

As used in this specification and any claims of this application, the terms “computer”, “server”, “processor”, and “memory” all refer to electronic or other technological devices. These terms exclude people or groups of people. For the purpose of the specification, the terms display or displaying means displaying on an electronic device. As used in this specification and any claims of this application, the terms “computer-readable media” and “computer readable medium” are entirely restricted to tangible, physical objects that store information in a form that is readable by a computer. These terms exclude any wireless, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, or any other available monitor types, for displaying information to the user and a keyboard and a pointing device, e.g., mouse or trackball, by which the user can provide input to the computer. Other kinds of devices can be used to provide for interaction with a user as well; for example, feedback provided to the user can be any form of sensory feedback, e.g., visual feedback, tactile feedback, or auditory feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication network include a local area network (“LAN”), an inter-network (e.g., the Internet), and peer-to-peer networks (e.g., ad-hoc peer-to-peer networks).

The subject matter described in this specification can be implemented using client-side applications, web pages, mobile web pages, or other software as generally known in the art and that would be usable to end-user customers (for community self-managed RAN apps) and/or mobile operator end users. The subject matter could alternately be delivered or implemented using an API, such as a SOAP API, a JSON API, a RESTful API, in lieu of or in conjunction with a direct end-user interface. The subject matter could use messaging queues, webhooks, server-side containers, or any other technology known in the art.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purpose of displaying data to and receiving user input from a user interacting with the client device). Data generated at the client device (e.g., a result of the user interaction) can be received from the client device at the server. Any database could be used (SQL, NoSQL, temporal, key-value, etc.). Any container orchestration technology (Kubernetes, Docker Swarm) could be used.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in singular is not intended to mean “one and only one” unless specifically so states, but rather “one or more.” Unless expressly stated otherwise, the term “some” refers to one or more. Pronouns in the masculine (e.g., his) include the feminine and neuter gender (e.g., her and its) and vice versa. Headings and subheadings, if any, are used for convenience only, and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations or one or more configurations. A phrase, for example, a configuration may refer to one or more configurations and vice versa.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, cloud topology could vary and public and private cloud services could be mixed; certain services could be provided by containers while other services could be provided by dedicated machines or virtual machines or virtual network functions (for example, a data sink could be a traditional billing server); wireless network topology can also apply to wired networks, optical networks, and the like; etc. The methods may apply to LTE-compatible networks, to UMTS-compatible networks, or to networks for additional protocols that utilize radio frequency data transmission. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Accordingly, the disclosure of the present invention is intended to be illustrative of, but not limiting of, the scope of the invention, which is specified in the following claims.

What is claimed is:

1. A method for providing an indication of a decoding problem, comprising:
detecting a problem in decoding uplink physical control channels for a Dedicated Physical Control Channel (DPCCH) or an Enhanced Dedicated Physical Control Channel (E-DPCCH);
sending a modified Up Link (UL) Dedicated Channel (DCH) frame having a spare field modified to indicate a Transport Format Combination Indicator (TFCI) decode failure; and
in response to receiving the modified UL DCH frame, controlling an Up Link (UL) Outer-Loop Power Control (OLPC) to keep a signal-to-interference ratio (SIR) of the UL DPCCH within a predetermined range.

2. The method of claim 1, wherein the sending the modified UL DCH frame is used for 2G, 3G, 4G, Long-Term Evolution (LTE) or 5G Radio Access Technologies (RATs).

3. The method of claim 1, further comprising using, by the OLPC, the modified UL DCH frame to readjust gain factors.

4. The method of claim 1, further comprising using, by the OLPC, the modified UL DCH frame to readjust power offsets.

5. The method of claim 1, further comprising using, by the OLPC, the modified UL DCH frame to optimize power consumption of uplink control and data channels to maximize cell capacity.

6. The method of claim 1, further comprising using, by the OLPC, the modified UL DCH frame offline to readjust gain factors.

7. The method of claim 1, further comprising using, by the OLPC, the modified UL DCH frame offline to readjust power offsets.

8. The method of claim 1, further comprising using, by the OLPC, the modified UL DCH frame offline to optimize power consumption of uplink control and data channels to maximize cell capacity.

9. The method of claim 1, further comprising using, by the OLPC, the modified UL DCH frame to set a low-bound limit in an SIR target to ensure the DPCCH and the E-DPCCH SIR do not fall below the low-bound limit.

10. A non-transitory computer-readable medium containing instructions which, when executed, cause a wireless communications system to perform steps comprising:
detecting a problem in decoding uplink physical control channels for a Dedicated Physical Control Channel (DPCCH) or an Enhanced Dedicated Physical Control Channel (E-DPCCH);
sending a modified Up Link (UL) Dedicated Channel (DCH) frame having a spare field modified to indicate a Transport Format Combination Indicator (TFCI) decode failure; and
in response to receiving the modified UL DCH frame, controlling an Up Link (UL) Outer-Loop Power Control (OLPC) to keep a signal-to-interference ratio (SIR) of the UL DPCCH within a predetermined range.

11. The non-transitory computer-readable medium of claim 10, further comprising instructions wherein the modified UL DCH frame is used for 2G, 3G, 4G, Long-Term Evolution (LTE) and 5G Radio Access Technologies (RATs).

12. The non-transitory computer-readable medium of claim 10, further comprising instructions wherein the OLPC uses the modified UL DCH frame to readjust gain factors

13. The non-transitory computer-readable medium of claim 10, further comprising instructions wherein the OLPC uses the modified UL DCH frame to readjust power offsets.

14. The non-transitory computer-readable medium of claim 10, further comprising instructions wherein the OLPC uses the modified UL DCH frame to optimize power consumption of uplink control and data channels to maximize cell capacity.

15. The non-transitory computer-readable medium of claim 10, further comprising instructions wherein the OLPC uses the modified UL DCH frame offline to readjust gain factors.

16. The non-transitory computer-readable medium of claim 10, further comprising instructions wherein the OLPC uses the modified UL DCH frame offline to readjust power offsets.

17. The non-transitory computer-readable medium of claim 10, further comprising instructions wherein the OLPC uses the modified UL DCH frame offline to optimize power consumption of uplink control and data channels to maximize cell capacity.

18. The non-transitory computer-readable medium of claim 10, further comprising instructions wherein the OLPC uses the modified UL DCH frame to set a low-bound limit in an SIR target to ensure the DPCCH and the E-DPCCH SIR does not fall below the low-bound limit.

19. A system for providing an indication of a decoding problem, comprising:
a User Equipment (UE);
a base station in wireless communication with the UE;
wherein a problem is detected by the UE in decoding uplink physical control channels for a Dedicated Physical Control Channel (DPCCH) or an Enhanced Dedicated Physical Control Channel (E-DPCCH);
wherein, in response to the problem being detected, a modified Up Link (UL) Dedicated Channel (DCH) frame is sent by the UE to the base station, the frame having a spare field modified to indicate a Transport Format Combination Indicator (TFCI) decode failure; and
wherein, in response to the base station receiving the modified UL DCH frame, an Up Link (UL) Outer-Loop Power Control (OLPC) is controlled to keep a signal-to-interference ratio (SIR) of the UL DPCCH within a predetermined range.
